(19) United States
(12) Patent Application Publication
(10) Pub. No.: US 2024/0107504 A1
(43) Pub. Date: Mar. 28, 2024

(54) Transmission Methods for Low Latency IEEE 802.11bx Communications

(71) Applicant: Apple Inc., Cupertino, CA (US)

(72) Inventors: Lochan Verma, Danville, CA (US); Jarkko L. Kneckt, Los Gatos, CA (US); Yong Liu, Campbell, CA (US); Jinjing Jiang, Cupertino, CA (US); Ahmad Reza Hedayat, Carlsbad, CA (US); Tianyu Wu, Fremont, CA (US)

(21) Appl. No.: 18/472,612

(22) Filed: Sep. 22, 2023

Related U.S. Application Data
(60) Provisional application No. 63/415,861, filed on Oct. 13, 2022.
(60) Provisional application No. 63/409,339, filed on Sep. 23, 2022.

(51) Int. Cl. H04W 72/0446; H04W 72/232; H04W 72/542; H04W 74/08

(52) U.S. Cl. CPC H04W 72/0446; H04W 72/232; H04W 72/542; H04W 74/0833; H04W 84/12

(57) ABSTRACT

Multiuser (MU) Multi-TID (multi-traffic-identifier) transmission may be enabled in a resource unit (RU). To transmit an urgent payload as soon as possible, the urgent payload may be injected/included into the ongoing MU physical protocol data unit (MU PPDU), if possible. This may be accomplished by indicating to the latency-sensitive wireless station (STA) the ID of a companion (or buddy) station that has an assigned resource unit (RU) on which the STA may expect to receive the urgent payload, also referred to as the “overloaded RU.” Alternatively, an extra user field in the preamble of the MU PPDU may be used to indicate to the STA its station ID as well as the location of the overloaded RU. A receiver operating on an A-MPDU may select the RU it receives, and may identify (or determine) a wrong transmission based on the transmitter address.

### PRIORITY CLAIM

This application claims benefit of priority of U.S. provisional application Ser. No. 63/415,861 titled “Transmission Methods for Low Latency IEEE 802.11bx Communications”, filed Oct. 13, 2022, and further claims benefit of priority to U.S. provisional application Ser. No. 63/409,339 titled “Transmission Methods for Low Latency IEEE 802.11bx Communications”, filed Sep. 23, 2022, both of which are hereby incorporated by reference in their entirety as though fully and completely set forth herein.

### FIELD OF THE INVENTION

The present application relates to wireless communications, including transmission methods for low latency communications, for example, for IEEE 802.11bx communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards.

One popular short/intermediate range wireless communication standard is wireless local area network (WLAN). Most modern WLANs are based on the IEEE 802.11 standard (or 802.11, for short). WLANs are marketed under the Wi-Fi brand name. WLAN networks link one or more devices to a wireless access point, which in turn provides connectivity to the wider area Internet. In 802.11 systems, devices that wirelessly connect to each other are referred to as “stations”, “mobile stations”, “user devices” or STA or UE for short. Wireless stations can be either wireless access points or wireless clients (or mobile stations). Access points (APs), which are also referred to as wireless routers, act as base stations for the wireless network. APs transmit and receive radio frequency signals for communication with wireless client devices. APs can also typically couple to the Internet in a wired fashion. Wireless clients operating on an 802.11 network can be any of various devices such as laptops, tablet devices, smart phones, or fixed devices such as desktop computers. Wireless client devices are referred to herein as user equipment (or UE for short). Some wireless client devices are also collectively referred to herein as mobile devices or mobile stations (although, as noted above, wireless client devices overall may be stationary devices as well).

Another popular short/intermediate range wireless communication standard is wireless personal area network (WPAN). Most modern WPANs are based on the IEEE 802.15 standard (or 802.15, for short.) WPAN networks link together one or more personal devices that are within effective communication range of each other. The IEEE 802.15.4 standard more specifically deals with low data rates and very long battery life (months or even years) at very low complexity. IEEE 802.15.4a is an amendment to IEEE 802.15.4 specifying additional physical layers (PHYs) to the original standard to provide higher precision ranging and localization capability (e.g., 1 meter or better accuracy), higher aggregate throughput, added scalability to data rates, longer range, and lower power consumption and cost.

The additional PHYs include an ultra-wideband (UWB) Pulse Radio (operating in the unlicensed UWB spectrum) and a chirp spread spectrum (operating in the unlicensed 2.4 GHz spectrum). UWB is characterized by the use of very low energy level for short-range, high-bandwidth (e.g., over 500 MHz) communications over a large portion of the radio spectrum. The International Telecommunication Union Radiocommunication Sector (ITU-R) currently defines UWB as a signal bandwidth that exceeds the lesser of 500 MHz or 20% of the arithmetic center frequency. Thus, pulse-based systems—where each transmitted pulse occupies the UWB bandwidth or an aggregate of at least 500 MHz of a narrow-band carrier (for example, orthogonal frequency-division multiplexing (OFDM))—can access the UWB spectrum under the rules. IEEE 802.15.4b provides specific enhancements and clarifications to IEEE 802.15.4a, such as resolving ambiguities, reducing unnecessary complexity, increasing flexibility in security key usage, and considering newly available frequency allocations, among others.

Channel access delay and duration of current transmissions are two critical factors that can cause transmission delays of latency-sensitive payloads) to a wireless station. Improvements are therefore desired.

### SUMMARY OF THE INVENTION

Embodiments are presented herein of, inter alia, of methods and procedures for efficient wireless communications, e.g., efficient low-latency communications in IEEE 802.11bx networks. Embodiments are further presented herein for wireless communication systems containing at least wireless communication devices or user equipment devices (UEs) and/or access points (APs) communicating with each other within the wireless communication systems.

Multiuser (MU) Multi-TID (multi-traffic-identifier) transmission may be enabled in a single resource unit (RU), targeting multiple recipients, e.g., from a common transmitter. To transmit an urgent payload as soon as possible, the urgent payload may be injected/included into an MU physical protocol data unit (MU PPDU) already intended for transmission to at least one other wireless station. This may be accomplished by indicating to the latency-sensitive wireless station (STA) the ID of a companion (or buddy) station that has an assigned resource unit (RU) on which the STA may expect to receive the urgent payload. Such an RU may be referred to as an “overloaded RU.” Alternatively, an extra user field in the preamble of the MU PPDU may be used to indicate to the STA its station ID as well as the location of the overloaded RU, e.g., via parameters identifying the RU. A receiver operating on an A-MPDU may select the RU on which to receive. The receiver may further identify (or determine) a wrong transmission based on the transmitter address. In case of a correctly identified transmission, the receiver may determine which MPDUs to receive based on the RA address that identifies or is associated with the receiver as conveyed in the MU PPDU.

### Payloads and Latency Sensitive Payloads

In some embodiments, an apparatus, device, or wireless station may operate to cause the wireless station to receive a payload, which may be a latency-sensitive payload in some embodiments, from a transmitter (e.g., from an access point, AP), on a resource unit (RU) on which communications are currently ongoing between the transmitter (e.g., AP) and a second wireless station. The wireless station may receive the (latency-sensitive) payload in a multiuser physical protocol data unit (MU PPDU). The wireless station may also receive information instructing the wireless station to monitor the RU with the expectation of receiving the latency-sensitive payload on the RU. In some embodiments, the information may include a station identifier identifying the second wireless station as a companion station to the wireless station, with the wireless station monitoring an RU associated with the companion station. The wireless station may search a preamble of a received packet to determine whether it indicates that an RU is allocated to the companion station, and may listen for the latency-sensitive packet on the RU in response to determining that an RU is allocated to the companion station. In some embodiments, an identifier value identifying the companion station may change after a specified time period or after a specified number of packets have been received by the wireless station.

The wireless station may receive information in a dedicated user field in a preamble of a received packet, with the information including a station identifier of the wireless station and further including an identifier of the RU. RU properties for receiving the (latency-sensitive) payload on the RU may be different relative to RU properties for the communications currently ongoing on the RU between the transmitter (or AP) and the second wireless station. A first portion of the preamble may provide an indication of a presence of the dedicated user field in the preamble. The wireless station may transmit a delayed block acknowledgment to the transmitter (or AP) in response to successfully receiving the latency-sensitive payload.

In general, in some embodiments, a wireless station may receive a payload from a transmitter on a resource unit (RU) on which communications between the transmitter and a second wireless station are also taking place. The wireless station may receive the payload in a multiuser physical protocol data unit (MU PPDU). The payload may be a latency-sensitive payload.

### Multi-User Physical Protocol Data Units

In some embodiments, a wireless station may detect a newly transmitted multiuser physical protocol data unit (MU PPDU), determine whether to receive a frame within the MU PPDU, and receive a resource unit (RU) associated with an association identifier (AID) that is first in a reception order. The wireless station may select received media access control packet data units (MPDUs) based on transmitter address and receiver address of the frame, and if the transmitter address does not match an access point (AP) address, stop RU reception, otherwise receive the MPDUs and prepare a block acknowledgment corresponding to the received MPDUs.

In some embodiments, a wireless station may detect a newly transmitted MU PPDU, determine, based at least on first information within a preamble of the MU PPDU, whether to receive a frame within the MU PPDU, identify, based at least on second information within the preamble, an RU, and select, based at least on a transmitter address and a receive address indicated by the MU PPDU, which MPDUs contained in the MU PPDU to receive over the RU. The wireless station may stop reception on the RU if the transmitter address does not match an assumed transmitter address. The wireless station may receive the MPDUs and prepare block acknowledgment corresponding to the received MPDUs. In some cases, the second information may include an association identifier (AID) associated with the RU, where the AID is first in a reception order of received AIDs.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an example WLAN communication system, according to some embodiments.

FIG. 2 illustrates an example simplified block diagram of a WLAN Access Point (AP), according to some embodiments.

FIG. 3A (3) illustrates an example simplified block diagram of a mobile station (UE), according to some embodiments.

FIG. 3B (4) illustrates an example simplified block diagram of an Internet of Things (IoT) station, according to some embodiments.

FIG. 4 shows an example timing diagram illustrating the transmission delay of an urgent payload transmission, according to prior art;

FIG. 5 shows an example diagram illustrating multiuser physical protocol data unit (MU PPDU) fields;

FIG. 6 shows an example diagram illustrating MU PPDU fields, emphasizing a resource unit (RU) that may be shared at least two stations, according to some embodiments;

FIG. 7 shows an example diagram illustrating RU allocation signaling, indicating a companion station associated with a latency-sensitive station, according to some embodiments;

FIG. 8 shows an example diagram illustrating MU PPDU fields that include a special extra user field for indicating an overloaded RU, according to some embodiments;

FIG. 9 shows exemplary tables with parameters and exemplary values for A-MPDU aggregation modes in the current IEEE 802.11 standard;

FIG. 10 shows exemplary tables with parameters and exemplary values for A-MPDU aggregation modes modified to enable multiple receivers identified with the same receiver address, according to some embodiments;

FIG. 11 shows an example diagram illustrating an A-MPDU field structure;

FIG. 12 shows example tables indicating DL RU parameters, DL RU subfields in EHT OMI, and DL RU configuration frame, and an example timing diagram for setup signaling, according to some embodiments;

FIG. 13 shows an example received RU selection table summarizing AID receive order of DL RU allocations, according to some embodiments;

FIG. 14 shows an example flow diagram illustrating a receiver operation on an A-MPDU, according to some embodiments; and

FIG. 15 shows example tables summarizing an AP MLD architecture and example link specific settings, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
UE: User Equipment
AP: Access Point
DL: Downlink (from AP to UE)
UL: Uplink (from UE to AP)
TX: Transmit/Transmission
RX: Receive/Reception
LAN: Local Area Network
WLAN: Wireless LAN
WPAN: Wireless Personal Area Network
RAT: Radio Access Technology
STA: (Wireless) Station
PE: Privacy Enhanced
BSS: Basic Service Set
UWB: Ultra-Wideband
NB: Narrowband
ACP: Acquisition Packet
TI: Transmission Interval
CAP: Contention Access Period
CFP: Contention Free Period
PLCP: Physical Layer Convergence Protocol
PSDU: PLCP Service Data Unit (Physical Layer Service Data Unit)
MAC: Media Access Control
MPDU: MAC (Layer) Protocol Data Unit
PPDU: Physical (Layer) Protocol Data Unit
PHY: Physical (Layer)
BPRF: Base Pulse Repetition Frequency
HRP: High-Rate Pulse Repetition Frequency
ERDEV: Enhanced Ranging Devices
QPSK: Quadrature Phase Shift Keying
DST: Destination (station or terminal)
RA: Receiver Address
TA: Transmitter Address
BA: Block Acknowledgment
TID: Traffic Identifier
MGMT: Management
MU: Multi User
AID: Association ID
MLD: Multilink Device
EHT: Extremely High Throughput
OMI: Operation Mode Indication
A-MPDU: Aggregate MAC Protocol Data Unit
QoS: Quality of Service
P2P: Peer to Peer

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPGAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™, Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. 5G NR, LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Processor—refers to various elements (e.g., circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RB s. The number of RBs within one RBG may differ depending on the system bandwidth.

Resource Unit (RU)—The term “resource unit” has the full extent of its ordinary meaning. In some embodiments, it may refer to a unit in OFDMA terminology, for example as used in the context of 802.11 networks, to denote a group of subcarriers (tones) each having a same specified bandwidth, e.g., 78.125 kHz bandwidth, used in both Downlink (DL) and Uplink (UL) transmissions. With OFDMA, different transmit powers may be applied to different RUs. In some cases, there may be a maximum of 9 RUs for 20 MHz bandwidth, 18 in case of 40 MHz and more in case of 80 or 160 MHz bandwidth.

Bandwidth Part (BWP)—A carrier bandwidth part (BWP) is a contiguous set of physical resource blocks selected from a contiguous subset of the common resource blocks for a given numerology on a given carrier. For downlink, a UE may be configured with up to a specified number of carrier BWPs (e.g. four BWPs, per some specifications), with one BWP per carrier active at a given time (per some specifications). For uplink, the UE may similarly be configured with up to several (e.g. four) carrier BWPs, with one BWP per carrier active at a given time (per some specifications). If a UE is configured with a supplementary uplink, then the UE may be additionally configured with up to the specified number (e.g. four) carrier BWPs in the supplementary uplink, with one carrier BWP active at a given time (per some specifications).

Multi-cell Arrangements—A Master node is defined as a node (radio access node) that provides control plane connection to the core network in case of multi radio dual connectivity (MR-DC). A master node may be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE may typically apply radio link monitoring to the PCell. If the UE is configured with an SCG then the UE may also apply radio link monitoring to the PSCell. Radio link monitoring is generally applied to the active BWPs and the UE is not required to monitor inactive BWPs. The PCell is used to initiate initial access, and the UE may communicate with the PCell and the SCell via Carrier Aggregation (CA). Currently Amended capability means a UE may receive and/or transmit to and/or from multiple cells. The UE initially connects to the PCell, and one or more SCells may be configured for the UE once the UE is in a connected state.

Core Network (CN)—Core network is defined as a part of a 3GPP system which is independent of the connection technology (e.g. the Radio Access Technology, RAT) of the UEs. The UEs may connect to the core network via a radio access network, RAN, which may be RAT-specific.

Personal Hotspot—Mobile devices may have the capability of sharing their cellular link(s)—meaning communication over the cellular link(s)—and/or internet connection with other connected devices. Such mobile devices may be linked to the other devices via one of many different links, for example via a wireless local area network (Wi-Fi), over Bluetooth or via a cabled connection such as USB, just to name a few. A device that wirelessly shares its cellular link(s) and/or internet connection with other devices is oftentimes referred to as a personal hotspot (PHS; or mobile hotspot), which effectively enables the device to operate as a portable router. Personal hotspots may be protected by a PIN or password, and an Internet-connected and/or cellular capable mobile device may thereby serve as a portable wireless access point and router for other devices that are connected to it.

BLUETOOTH™—The term “BLUETOOTH™” has the full breadth of its ordinary meaning, and at least includes any of the various implementations of the Bluetooth standard, including Bluetooth Low Energy (BTLE) and Bluetooth Low Energy for Audio (BTLEA), including future implementations of the Bluetooth standard, among others.

Personal Area Network—The term “Personal Area Network” has the full breadth of its ordinary meaning, and at least includes any of various types of computer networks used for data transmission among devices such as computers, phones, tablets and input/output devices. Bluetooth is one example of a personal area network. A PAN is an example of a short-range wireless communication technology.

BSS Coloring—Unnecessary medium contention overhead that occurs when too many access points (APs) and clients hear each other on the same channel is called an overlapping basic service set (OBSS). The more commonly used terminology for OBSS is co-channel interference (CCI). BSS coloring is a method for identifying OB SSs.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

The headings used herein are for organizational purposes only and are not meant to be used to limit the scope of the description. As used throughout this application, the word “may” is used in a permissive sense (e.g., meaning having the potential to), rather than the mandatory sense (e.g., meaning must). The words “include,” “including,” and “includes” indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third component electrically connected to the module substrate” does not preclude scenarios in which a “fourth component electrically connected to the module substrate” is connected prior to the third component, unless otherwise specified. Similarly, a “second” feature does not require that a “first” feature be implemented prior to the “second” feature, unless otherwise specified.

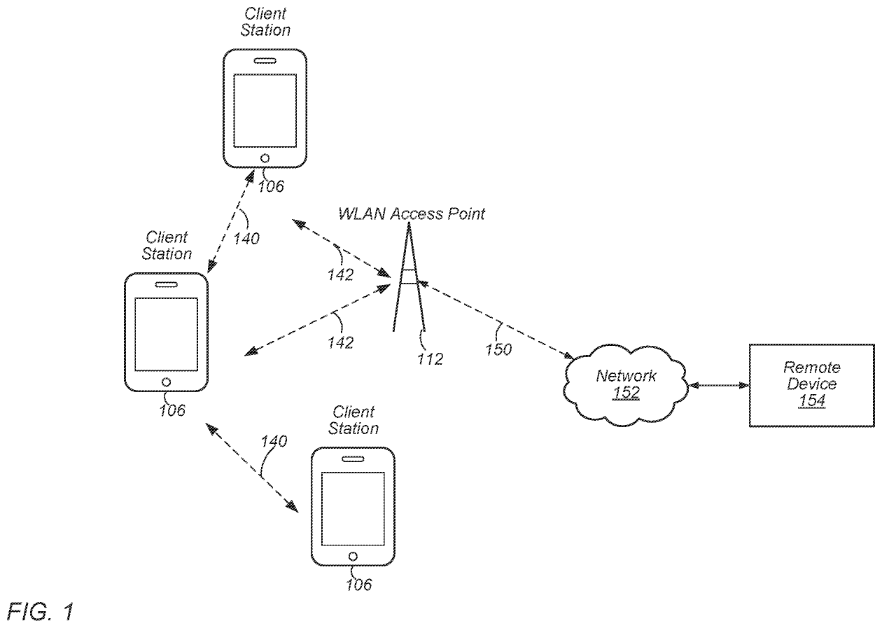

### FIG. 1—WLAN/WPAN System

FIG. 1 illustrates an example WLAN/WPAN system according to some embodiments. As shown, the exemplary WLAN/WPAN system includes a plurality of wireless client stations or devices, or user equipment (UEs), 106 that may communicate over a wireless communication channel 142 with an Access Point (AP) 112. The AP 112 may be a Wi-Fi access point. The AP 112 may communicate via a wired and/or a wireless communication channel 150 with one or more other electronic devices (not shown) and/or another network 152, such as the Internet. Additional electronic devices, such as the remote device 154, may communicate with components of the WLAN/WPAN system via the network 152. For example, the remote device 154 may be another wireless client station. The WLAN/WPAN system may operate according to any of various communications standards, such as the various IEEE 802.11 and IEEE 802.15 standards. Accordingly, in addition to communicating via AP 112, wireless devices 106 may communicate directly with one or more neighboring mobile devices (e.g., via direct communication channels 140), without use of the access point 112.

In some embodiments, as further described below, a wireless device 106 may perform methods for reducing delay in transmission of latency-sensitive Mac Protocol Data Units (MPDUs) to a station (STA) if the MPDUs arrive during an ongoing current transmission that does not include the STA as a destination (DST).

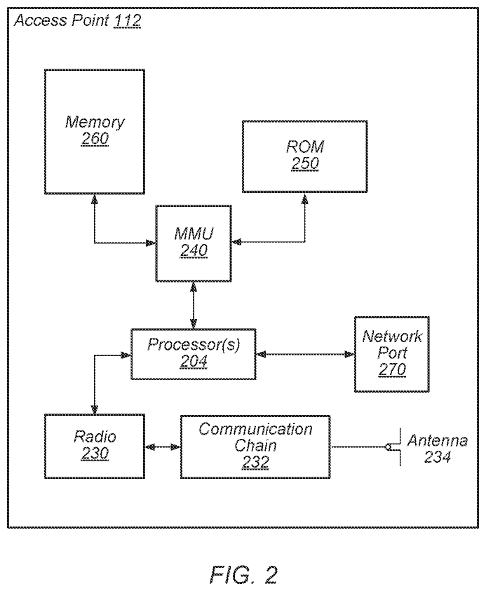

### FIG. 2—Access Point Block Diagram

FIG. 2 illustrates an exemplary block diagram of an access point (AP) 112. It is noted that the block diagram of the AP of FIG. 2 is only one example of a possible system. As shown, the AP 112 may include processor(s) 204 which may execute program instructions for the AP 112. The processor(s) 204 may also be coupled (directly or indirectly) to memory management unit (MMU) 240, which receive addresses from the processor(s) 204 and to translate those addresses to locations in memory (e.g., memory 260 and read only memory (ROM) 250) or to other circuits or devices.

The AP 112 may include at least one network port 270. The network port 270 may couple to a wired network and provide a plurality of devices, such as mobile devices 106, access to the Internet. For example, the network port 270 (or an additional network port) may couple to a local network, such as a home network or an enterprise network. For example, port 270 may be an Ethernet port. The local network may provide connectivity to additional networks, such as the Internet.

The AP 112 may include at least one antenna 234, which may operate as a wireless transceiver and may be further configured to communicate with mobile device 106 via wireless communication circuitry 230. The antenna 234 communicates with the wireless communication circuitry 230 via communication chain 232. Communication chain 232 may include one or more receive chains, one or more transmit chains or both. The wireless communication circuitry 230 may communicate via Wi-Fi or WLAN, e.g., 802.11. The wireless communication circuitry 230 may also, or alternatively, communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it may be desirable for the AP 112 to communicate via various different wireless communication technologies. In some embodiments, as further described below, AP 112 may perform methods for reducing delay in transmission of latency-sensitive MPDUs to an STA if the MPDUs arrive during an ongoing current transmission that does not include the STA as a DST.

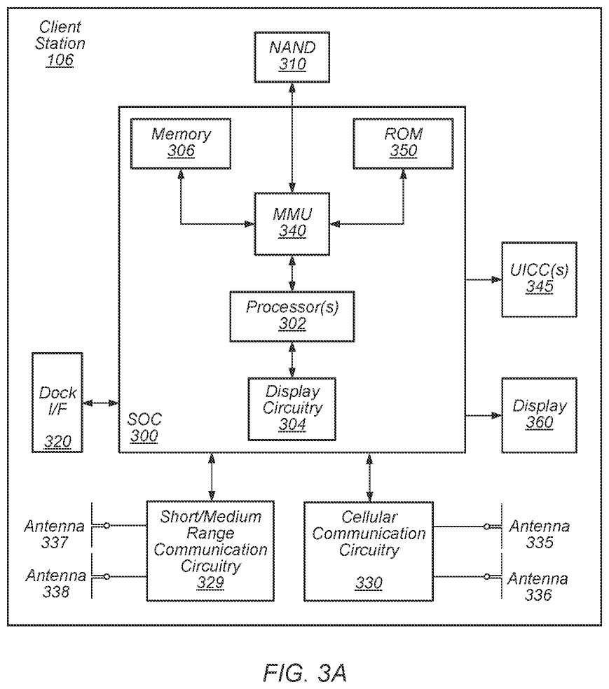

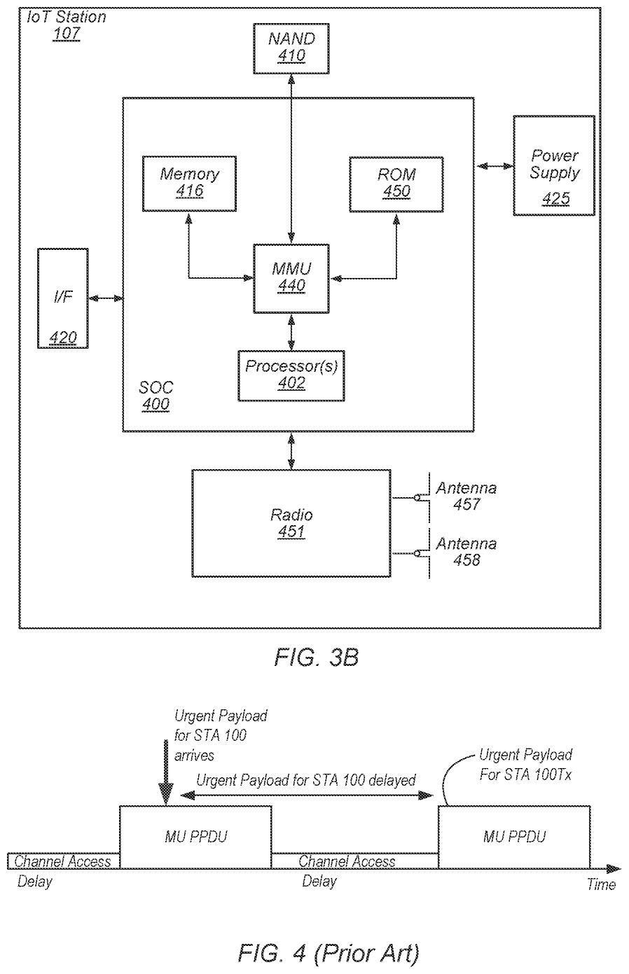

### FIG. 3A—Client Station Block Diagram

FIG. 3A illustrates an example simplified block diagram of a client station 106. It is noted that the block diagram of the client station of FIG. 3A is only one example of a possible client station. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (or dock) 320 (e.g., for coupling to a computer system, dock, charging station, etc.), the display 360, cellular communication circuitry 330 such as for LTE, GSM, etc., and short to medium range wireless communication circuitry 329 (e.g., Bluetooth™ and WLAN circuitry). The client station 106 may further include one or more smart cards 310 that incorporate SIM (Subscriber Identity Module) functionality, such as one or more UICC(s) (Universal Integrated Circuit Card(s)) cards 345. The cellular communication circuitry 330 may couple to one or more antennas, such as antennas 335 and 336 as shown. The short to medium range wireless communication circuitry 329 may also couple to one or more antennas, such as antennas 337 and 338 as shown. Alternatively, the short to medium range wireless communication circuitry 329 may couple to the antennas 335 and 336 in addition to, or instead of, coupling to the antennas 337 and 338. The short to medium range wireless communication circuitry 329 may include multiple receive chains and/or multiple transmit chains for receiving and/or transmitting multiple spatial streams, such as in a multiple-input multiple output (MIMO) configuration.

As shown, the SOC 300 may include processor(s) 302, which may execute program instructions for the client station 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 may perform memory protection and page table translation or set up. In some embodiments, the MMU 340 may be included as a portion of the processor(s) 302.

As noted above, the client station 106 may communicate wirelessly directly with one or more neighboring client stations. The client station 106 may be configured to communicate according to a WLAN RAT for communication in a WLAN network, such as that shown in FIG. 1. Further, in some embodiments, as further described below, client station 106 may perform methods for reducing delay in transmission of latency-sensitive MPDUs to an STA if the MPDUs arrive during an ongoing current transmission that does not include the STA as a DST.

As described herein, the client station 106 may include hardware and software components for implementing the features described herein. For example, the processor 302 of the client station 106 may implement part or all of the features described herein, e.g., by executing program instructions stored on a memory medium (e.g., a non-transitory computer-readable memory medium). Alternatively (or in addition), processor 302 may be a programmable hardware element, such as an FPGA (Field Programmable Gate Array), or as an ASIC (Application Specific Integrated Circuit). Alternatively (or in addition) the processor 302 of the UE 106, in conjunction with one or more of the other components 300, 304, 306, 310, 320, 330, 335, 340, 345, 350, 360 may be configured to implement part or all of the features described herein.

In addition, as described herein, processor 302 may include one or more processing elements. Thus, processor 302 may include one or more integrated circuits (ICs) that perform the functions of processor 302. In addition, each integrated circuit may include circuitry (e.g., first circuitry, second circuitry, etc.) to perform the functions of processor(s) 204.

Further, as described herein, cellular communication circuitry 330 and short-range wireless communication circuitry 329 may each include one or more processing elements. In other words, one or more processing elements may be included in cellular communication circuitry 330 and also in short range wireless communication circuitry 329. Thus, each of cellular communication circuitry 330 and short-range wireless communication circuitry 329 may include one or more integrated circuits (ICs) that are configured to perform the functions of cellular communication circuitry 330 and short-range wireless communication circuitry 329, respectively. In addition, each integrated circuit may include circuitry (e.g., first circuitry, second circuitry, etc.) to perform the functions of cellular communication circuitry 330 and short-range wireless communication circuitry 329.

### FIG. 3B: Internet of Things (IoT) Station

FIG. 3B illustrates an example simplified block diagram of an IoT station 107, according to some embodiments. According to embodiments, IoT station 107 may include a system on chip (SOC) 400, which may include one or more portions for performing one or more purposes (or functions or operations). The SOC 400 may be coupled to one or more other circuits of the IoT station 107. For example, the IoT station 107 may include various types of memory (e.g., including NAND flash 410), a connector interface (I/F) 420 (e.g., for coupling to a computer system, dock, charging station, light (e.g., for visual output), speaker (e.g., for audible output), etc.), a power supply 425 (which may be non-removable, removable and replaceable, and/or rechargeable), and communication circuitry (radio) 451 (e.g., BT/BLE and/or WLAN).

The IoT station 107 may include at least one antenna, and in some embodiments, multiple antennas 457 and 458, for performing wireless communication with a companion device (e.g., client station 106, AP 112, and so forth) as well as other wireless devices (e.g., client station 106, AP 112, other IoT stations 107, and so forth). In some embodiments, one or more antennas may be dedicated for use with a single radio and/or radio protocol. In some other embodiments, one or more antennas may be shared across two or more radios and/or radio protocols. The wireless communication circuitry 451 may include WLAN logic and/or WPAN logic, such as BT/BLE logic, for example. In some embodiments, the wireless communication circuitry 451 may include multiple receive chains and/or multiple transmit chains for receiving and/or transmitting multiple spatial streams, such as in a multiple-input multiple output (MIMO) configuration.

As shown, the SOC 400 may include processor(s) 402, which may execute program instructions for the IoT station 107. The processor(s) 402 may also be coupled (directly or indirectly) to memory management unit (MMU) 440, which may receive addresses from the processor(s) 402 and translate those addresses into locations in memory (e.g., memory 416, read only memory (ROM) 450, NAND flash memory 410) and/or to other circuits or devices, such as the wireless communication circuitry 451. The MMU 440 may perform memory protection and page table translation or set up. In some embodiments, the MMU 440 may be included as a portion of the processor(s) 402.

As noted above, the IoT station 107 may be configured to communicate wirelessly with one or more neighboring wireless devices. In some embodiments, as further described below, IoT station 107 may perform methods for reducing delay in transmission of latency-sensitive MPDUs to an STA if the MPDUs arrive during an ongoing current transmission that does not include the STA as a DST.

### FIG. 4: Channel Access Delay and Duration of Current Transmission(s)

Channel access delay and duration of current transmission are two critical factors that may delay transmission of latency-sensitive (or urgent) payload (e.g., Media Access Control Protocol Data Units—MPDUs) to a given STA not participating in the current transmission. Latency-sensitive MPDU transmission to the given STA is delayed until the next immediate transmit opportunity if this urgent payload arrives any time after start of the current transmission that does not include the given STA as a current destination (DST), and before the start of the next immediate transmission. There is therefore a need to reduce delay in transmission of latency-sensitive MPDUs to the given STA if the urgent payload arrives while current transmission that does not include the given STA as a DST is ongoing.

In IEEE 802.11 a typical packet, PPDU, transmission requires channel access. Various methods for channel access may be employed. Each channel access typically incurs a time overhead/penalty. The more STAs are present within a given area, the longer channel access may take for any given STA. While a transmitter is transmitting a packet, shown in FIG. 4 as the MU PPDU, it is possible, during the ongoing transmission, for an urgent payload to arrive for a station which is not part of the current transmission. For example, the transmitter may be transmitting to STA1, STA2, STA3 (for example), and during this transmission an urgent payload targeting STA100 may arrive. Per current implementations, the transmitter has to complete the current transmission, then wait for the next transmit opportunity to transmit this urgent payload to STA100. In other words, the transmitter has to contend for the channel, win the channel, i.e., gain access to the channel, then transmit the (new) urgent payload. This incurs a channel access delay.

As indicated in FIG. 4, the urgent payload for STA100 is delayed by a given period of time, or by a given time duration. It is desirable to reduce the latency in transmission of urgent payloads to STAs that are not participants in a currently ongoing transmission, since urgent payloads are typically time sensitive payloads. Ideally, the urgent payload would be transmitted as soon as it arrives. To transmit the urgent payload as soon as possible, the urgent payload may be injected/included into the ongoing MU PPDU, if possible.

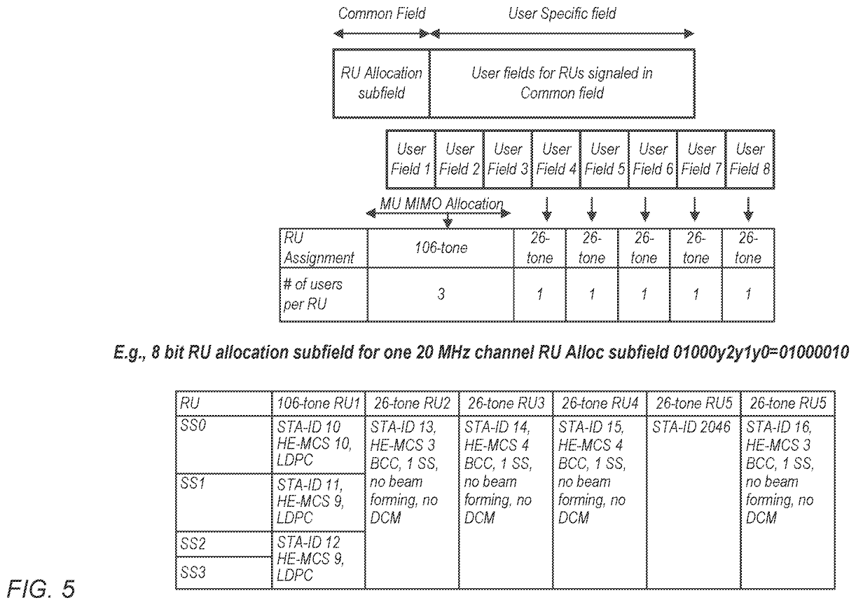

### FIG. 5: MU PPDU Fields

Some of the fields currently included in an MU PPDU per IEEE 802.11 standards are shown in FIG. 5. A common field indicates how a channel is partitioned into various RUs (Resource Units), while a user specific field indicates which user is assigned to which individual RU. In other words, the common field indicates how the resources are allocated to different destinations or users (STAs). FIG. 5 shows an example for a 20 MHz channel allocated to eight (8) users (STAs), and each of the users is assigned a small resource unit (RU) in the 20 MHz channel. The table at the bottom of FIG. 5 lists the possibilities for each of these users per current implementations.

The resource allocation may be indicated (e.g., by an AP) in a preamble (e.g., through the HE-SIG-B). It should be noted that RU allocation information is communicated to clients (STAs) at both the PHY and MAC layers. At the Physical layer, RU allocation information may be included in the HE-SIG-B field of the PHY header of an 802.11 trigger frame. In other words, the HE-SIG-B field is used to communicate RU assignments to clients. The HE-SIG-B field consists of two subfields, the common field and the user-specific field (as also indicated in FIG. 5). A subfield of the common field is used to indicate how a channel is partitioned into various RUs. For example, a 20 MHz channel might be subdivided into one 106-tone RU and four 26-tone RUs. The user-specific field includes multiple user fields that are used to communicate which users are assigned to each individual RU.

The fields shown in FIG. 5 may be leveraged to include/inject an urgent payload into an ongoing MU PPDU for the purposes mentioned above.

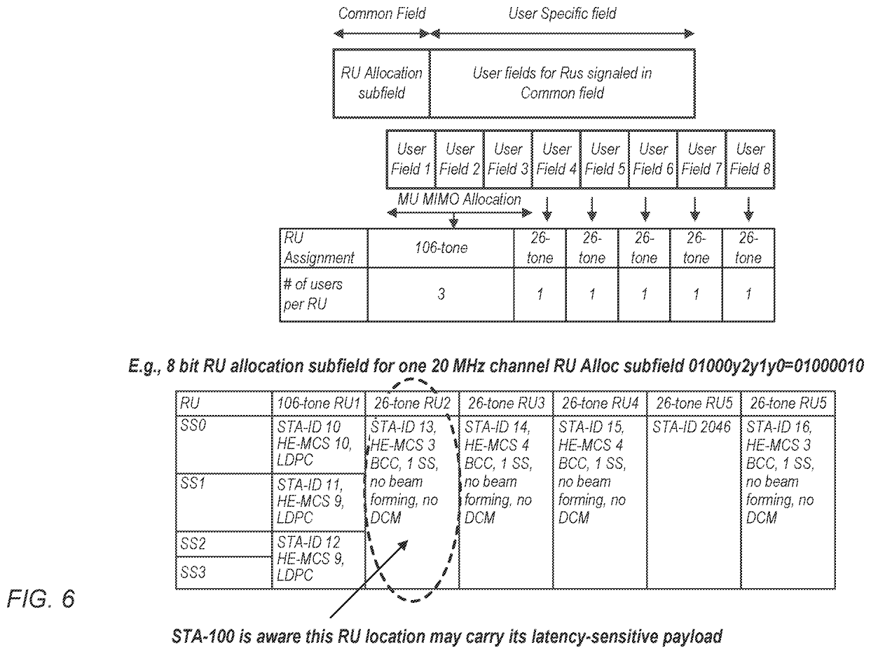

### FIG. 6: Multiuser Multi-TID Transmission in an RU

The goal is to enable MU Multi-TID (multi-traffic-identifier) transmission in an RU. One or more latency-sensitive STAs (e.g., STA-100) may have a-priori knowledge of the RU location in which they may receive latency-sensitive payload in this MU PPDU. Using STA100 as a station example, at the start of the MPDU, STA100 may be able to determine that it is possible for STA100 to receive some urgent payload at some point in time, and that this would occur at a certain specific resource allocation. Accordingly, all the resource associated properties and parameters would be known a priori by the STA. In other words, the latency-sensitive STA may receive all MPDUs on the indicated RU location. The indicated RU is circled in the exemplary diagram of FIG. 6.

Legacy IEEE 802.11ax/be STAs and latency-sensitive STAs may filter MPDUs with DST address mismatch. That is, WLAN communications include use of a receiver address and a destination address. The receiver is like the receiver of the transmission in this hop/air interface transmission, while the DST is the very last receiver (or final destination) of the frame. Typically, the receiver address (RA) identifies the receiver. As disclosed herein, the DST may cover both the receiver address and the destination address. Since it leverages existing frame fields, this feature is backward compatible with existing implementations, for example with Wi-Fi 6 and Wi-Fi 7 solutions. As illustrated in the example in FIG. 6, the information for the 26-tone RU2 may be equally applicable for station ID 13 (STA13) for STA100, since the latency-sensitive payload will be carried in RU2.

Details pertaining to the RU overloading introduced above are presented below.

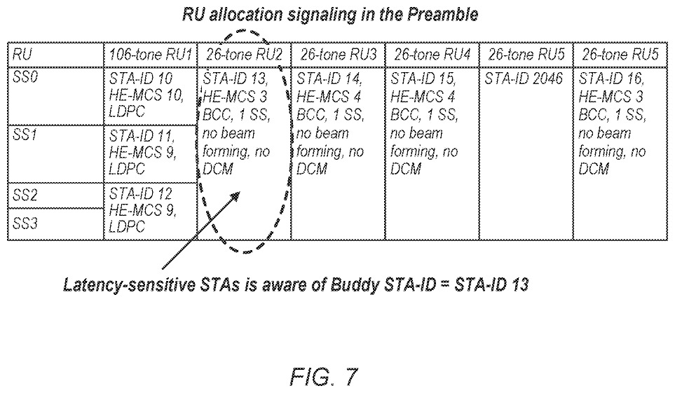

### FIG. 7: Resource Allocation Indication to Latency-Sensitive STA (First Option)

One method for indicating RU overloading may be by way of a buddy station ID, buddy STA-ID, or companion station ID. Whenever a client associates with an AP, the client is provided with an identifier referred to as a station identifier (STA-ID). When the latency-sensitive STA joins the network, the AP may inform the STA of the STA's station ID (in the previously introduced example the ID is 100, hence the station is referenced as STA100), and may also inform STA100 of its buddy/companion station (B STA) and that B STA's station ID. In the example shown in FIG. 7, the B STA-ID is 13 (STA13 indicated as STA-ID 13). Every time there is a DL MU PPDU, STA100 may parse the preamble of the PPDU, which includes the RU fields (common field and user-specific field), and may detect/identify the allocation(s) for STA13 in those fields, aware that STA13 is the buddy station of STA100. Accordingly, STA100 may be alert on the particular RU allocated to STA13, expecting arrival of urgent payload as STA13 is STA100's buddy station. From the perspective of STA13, the behavior does not change. STA13 may be a legacy station capable of parsing the signaling without any issues since the signaling structure has not been altered from the perspective of STA13. Because the RU associated with STA13 is being overloaded, at some point on that RU a payload intended for STA100 may also be transmitted. STA13 may simply discard that payload, e.g., using a filter based on destination address. The buddy station ID may be a special reserved value or a group value associated with multiple STAs expecting latency-sensitive payloads on a given RU or on respective given RUs. The buddy station ID may also be an AID assigned to another associated STA.

Pursuant to the above, a latency-sensitive STA may support a “Multi-User Multi-TID” feature and may be made aware of the “overloaded RU” by the AP. As noted above, the “overloaded RU” may be the RU allocated to a buddy STA-ID. One or more latency-sensitive STA(s) may search each MU PPDU (e.g., the preamble of the MU PPDU) to determine if their buddy-STA-ID is allocated an RU in the given MU PPDU. If an RU is allocated to the buddy-STA-ID, the latency-sensitive STAs may receive MU PPDUs on this “overloaded” RU. The buddy STA-ID may change over time (e.g., after a specified number of PPDUs) and may be signaled by the AP.

One benefit of the above approach is its backward compatibility as no changes are made to the existing preamble of MU PPDUs. One drawback is that latency-sensitive STAs and buddy STA-IDs use the same RU properties.

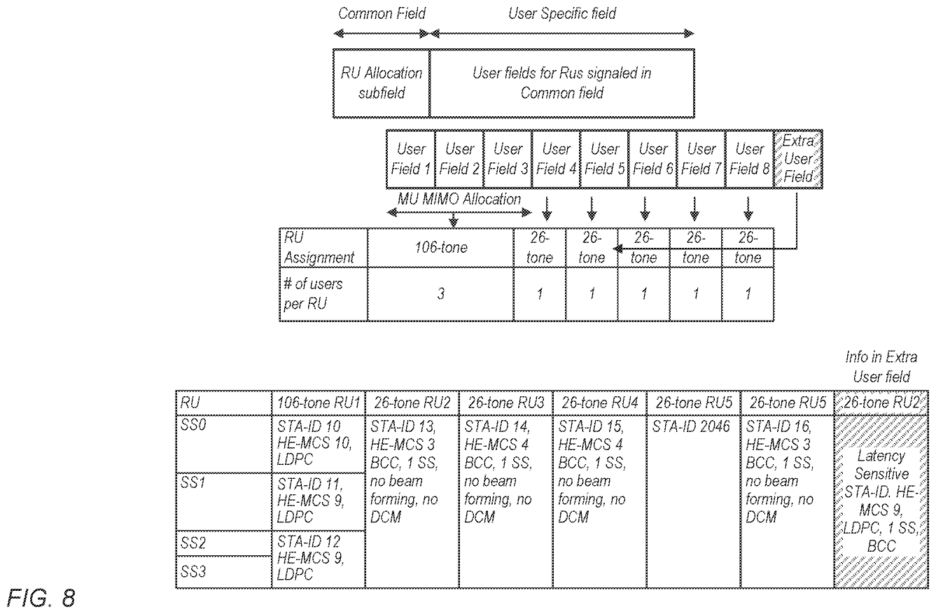

### FIG. 8: Resource Allocation Indication to Latency-Sensitive STA (Second Option)

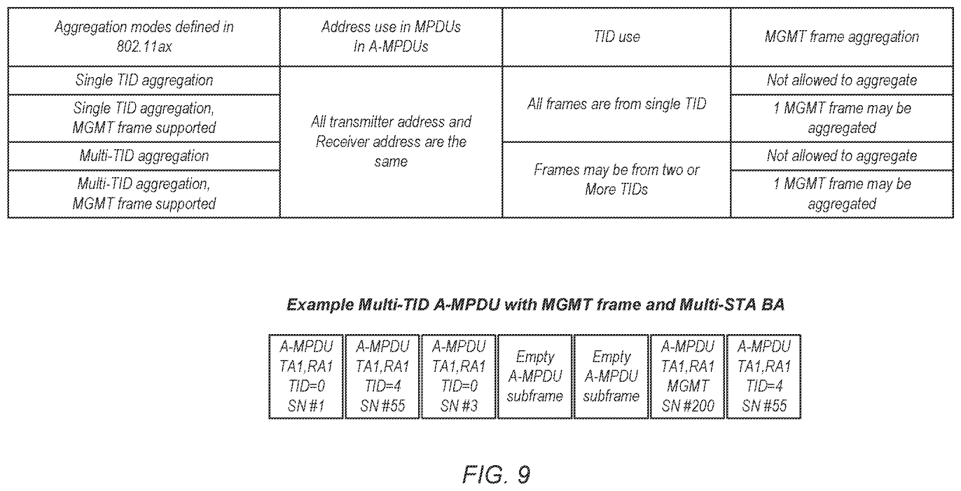

Another method for indicating RU overloading may be by way of the introduction of an extra (dedicated) user field in the PPDU preamble. As shown in FIG. 9, the extra user field may indicate at least two important pieces of information. The first information is the station ID of the latency-sensitive STA (STA100 for the previously introduced example.) The second information is the location of the RU that is being overloaded. The AP may thereby indicate which latency-sensitive STA needs to be on alert and monitor for an urgent payload. The extra user field also enables assignment of different RU properties to the RU for transmission of the latency-sensitive payload to STA100 relative to the RU properties for transmissions to the STA originally assigned to the RU, that is, for transmissions to buddy-station STA13.

Accordingly, a latency-sensitive STA may support “Multi-User Multi-TID” feature and may be made aware of an “overloaded RU” by the AP. The preamble (SIG-A) may indicate presence of an “extra user field” in the preamble (SIG-B). The extra user field may include information that enables one or more latency-sensitive STAs to receive MU PPDUs (e.g., carrying urgent payload) on the overloaded RU, if such MU PPDUs get transmitted.

Benefits of this approach include minimal change to the existing preamble, and allowing for different transmission properties on the “overloaded” RU. One drawback is the lack of backward compatibility as legacy STA calculation of the user specific field length will be incorrect.

The acknowledgement policy for transmission on an overloaded RU may be set such that one but not both of the STAs sends the immediate block acknowledgment (BA). For example, the immediate BA may be transmitted by the buddy STA. Other STA (e.g., STA-100) may transmit a delayed BA.

### FIG. 9: A-MPDU Aggregation Modes in MU PPDU Per Current IEEE 802.11 Standards

A transmitter may transmit an MU PPDU over one or more RUs. The MU PPDU may correspondingly include one or more payloads, with each payload corresponding to a respective RU of the one or more RUs. In short, this may be expressed as a transmitter transmitting “an MU PPDU that contains one or RUs”. An RU may thereby carry individually addressed MPDUs or group addressed MPDUs. To put it another way, individually addressed MPDUs or group addressed MPDUs may be carried over/via an RU. The MPDUs are carried in the A-MPDU subframes, and each A-MPDU subframe includes one MPDU. The preamble of the MU PPDU signals an RU indication, e.g., parameters or parameter values that identify the RU allocation and the target receiver associated with the RU. Typically, the individually addressed frames have the STA-ID field of the RU set to an association ID (AID) value associated with the receiver. When the RU carries individually addressed MPDUs, then currently, the receiver address (RA) and transmitter address (TA) field values in the MAC Headers of all MPDUs are set to the same values. In other words, there is one transmitter and one receiver associated with the RU that carries the MU PPDU. The MPDUs transmitted over an RU may be transmitted from different QoS priority levels, and may have different User Priority (UP) or Traffic Identifier (TID) values. In some embodiments, the payload may also contain a management frame.

A multi-STA BA may acknowledge all transmitted UP and TID configurations of a payload. Each TID has its own sequence number space, and a sequence number is used in the BA to detect whether a frame has been received. For instance, a BA may have a bitmap of sequence number values, and a value of “1” in this bitmap may indicate that an MPDU with the matching or corresponding sequence number has been received. In some embodiments, the receiver may also acknowledge a received management frame. The receiver receives the MPDU and checks the sequence number of the MPDU and marks the received MPDUs for each transmission. To look at it another way, one RU has one associated transmitter and one associated receiver. The transmitter and receiver may have different capability levels. One example of these capability levels is shown in exemplary table 902 of FIG. 9. Exemplary table 904 of FIG. 9 illustrates one example of a payload (including A-MPDU subframes or MPDUs) and is carried over an RU.

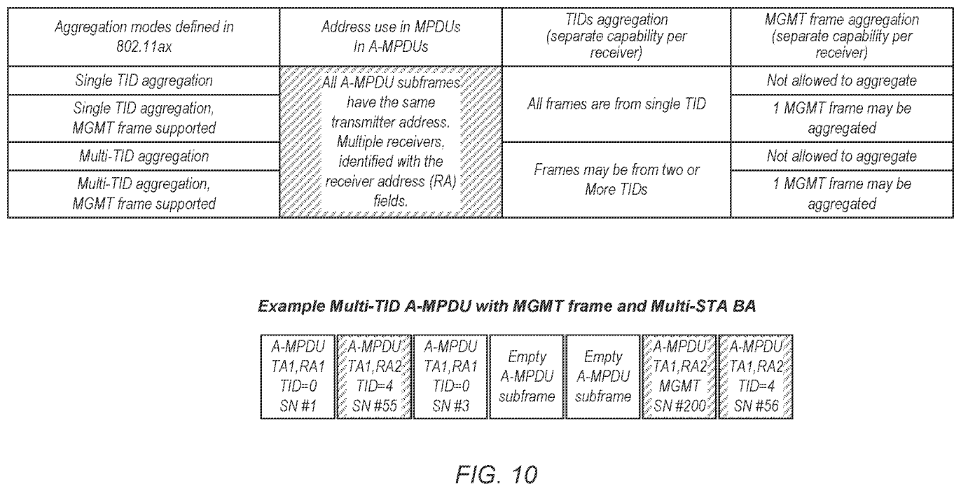

FIG. 10: A-MPDU Aggregation with Traffic to Two STAs

The shaded boxes in the tables of FIG. 10 feature differences relative to the similar tables of FIG. 9 when multiple users are allocated on the same resource (RU), according to some embodiments. As previously discussed, examples of allocating more than one receiver to a given RU are provided in FIGS. 7 and 8. When multiple devices receive transmissions on the same RU, different receive addresses may be included in the A-MPDU transmissions. Each recipient may be independent from other recipients, and capable of filtering out its own data. Once a recipient has received its own data, it will have the aggregation support level according to which it may create the BAs for the transmitted frames.

Accordingly, one transmitter may transmit frames to multiple receivers over/via the same RU. Therefore, the MPDUs in A-MPDU subframes may be associated with the same transmitter address (TA) but may be associated with different respective receiver addresses (RAs). In some embodiments, each receiver may have its A-MPDU aggregation capabilities configured separately as illustrated in exemplary table 1002 of FIG. 10. Exemplary table 1004 of FIG. 10 illustrates an example of Multi-TID A-MPDU with MGMT frame and Multi-STA BA. As illustrated in exemplary table 1004, a device having (or associated with) RA1 may be single-TID capable and may receive frames from TID 0. A device having (or associated with) RA2 may be multi-TID capable and may receive frames from TID 0 and TID 4. It should be noted that MPDUs may be in different order in the transmitted payload transmitted over/via the RU, and the transmitter may transmit frames to more than two devices over/via an RU.

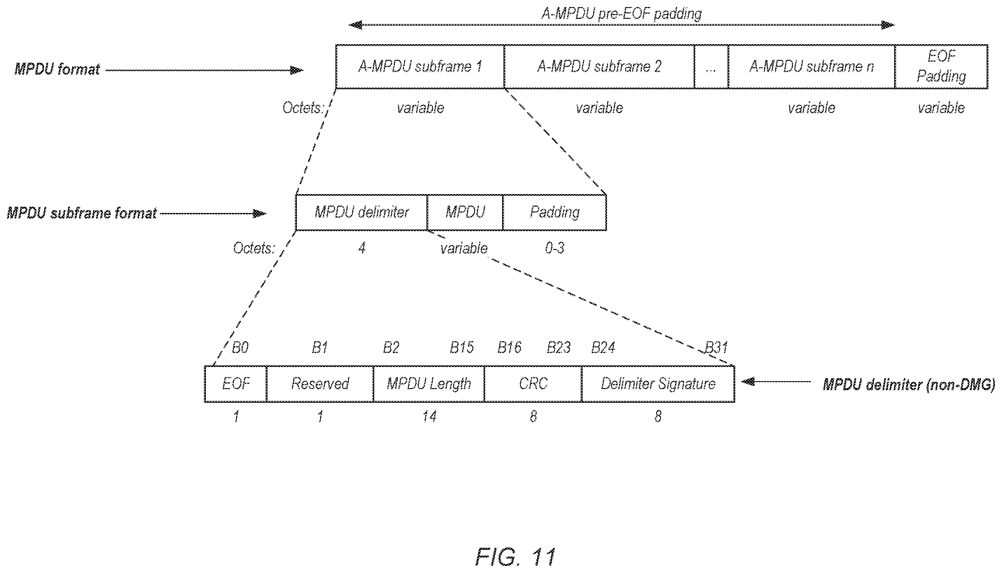

### FIG. 11: A-MPDU Field Structure

The A-MPDU subframe contains the MPDU delimiter common to all the receivers. The MPDU contains the transmit address, receive address, sequence numbers, etc. As previously mentioned, A-MPDUs may contain transmission to multiple receivers. A device intended to receive to receive the RU (e.g., a device intended to receive a respective payload over/via the RU) may check the MPDU to determine whether it (the device) is an intended target of the transmission. When a device is not an intended target, the device may discard the A-MPDU subframe and receive the next A-MPDU subframe over/via the RU. For example, the recipients may calculate the respective start and stop positions of the A-MPDU subframes, and check RA and TA in the MPDU. In some embodiments, the transmitter may add padding to transmissions. The padding may include A-MPDU subframes that have the MPDU length set to 0, e.g. Such A-MPDU subframes may not include an MPDU(s) (e.g., as designated by “Empty A-MPDU subframe” in table 1004 of FIG. 10.) The receivers may ignore such padding.

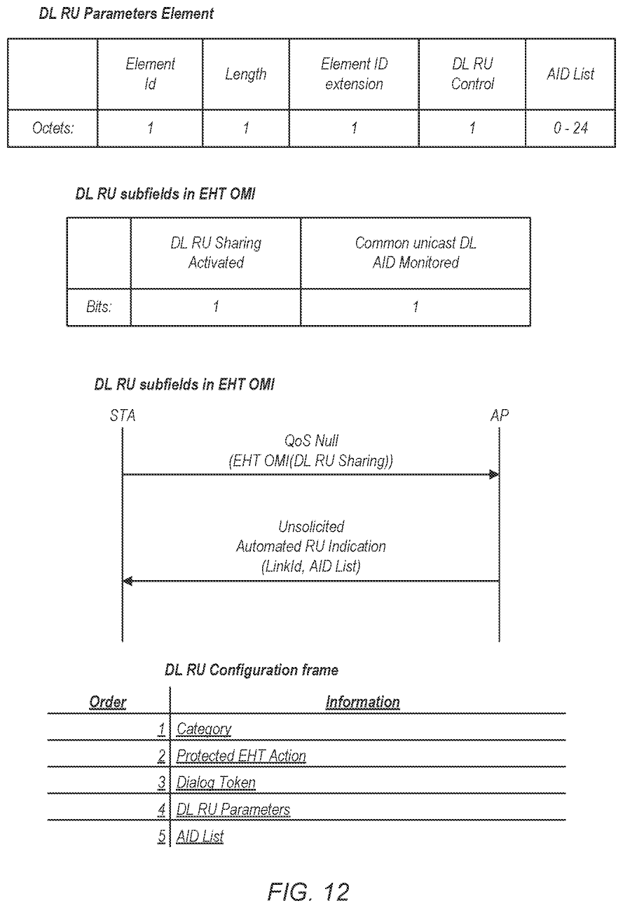

### FIG. 12: Capability and Setup Signaling

A DL MU RU Sharing Capability field in the Extended Capability element may signal whether the transmitter supports transmissions to multiple STAs over/via a single RU. E.g., a value of “1” in that field may indicate that the transmitter supports transmissions to multiple STAs in an RU (or over/via an RU). The AP may indicate this capability to STAs, e.g., in beacon frames and/or probe response frames. In some embodiments, the DL MU RU Sharing Capability may signal support to transmit and receive transmissions to multiple STAs in (or over/via) a given RU. For example, an STA operating in a mesh network or an STA with multiple P2P links may have the capability to send MU PPDUs to one or more receiving STAs over given RUs. Similarly, the device may receive MU PPDUs that allocate an RU to the device and to other STAs.

The non-AP STA may signal, e.g., in a (re)association request frame, whether it supports DL MU RU sharing and whether the sharing is activated. The non-AP STA may activate/deactivate its MU RU sharing or reception in common DL AID by sending a QoS Null frame or a data frame that contains an EHT OMI A-Control field in the MAC headers of the MPDUs.

The AP or AP MLD (Multi-Link Device; e.g., as illustrated in FIG. 15) may send the AID List size to signal the number of AID values that the STA is intended to receive, and also signal the respective listened AID values (e.g., AID values representative of buddy-IDs, as previously described). It should be noted that in this context, “listened AID” is used to reference STA-ID values used as RU indications in the MU PPDU preamble that the STA receives. The AP may change the listened AID values that the STA is intended to receive by sending a DL RU configuration frame. In some embodiments, the frame may be unsolicited and protected. The AP may again change the AID values that the STA receives by sending a second DL RU configuration frame. The additional AID value(s) associated with corresponding RU(s) which the STA may monitor may be associated with or may be shared with or between companion devices as previously disclosed above.

The AP may continuously monitor the transmission performance of the STAs. If the AP detects that an STA has moved and the current AID values that signal the received RUs are not in the best priority order or do not contain the AID values of other STAs that would enable the highest transmission rates, the AP may change the listened AID values and/or reorder the listened AID values.

In some embodiments, an STA may operate in multiple P2P connections. Each P2P connection may have two STAs. In these cases, the STA may use the same MAC address for all P2P peer STAs and transmit MU PPDU transmissions to the P2P devices. In this topology, the STA may have the same capabilities as the AP, and may allocate peer devices in P2P transmissions to receive multiple AID values. Accordingly, various embodiments of the mechanisms described herein are not limited to the infrastructure mode.

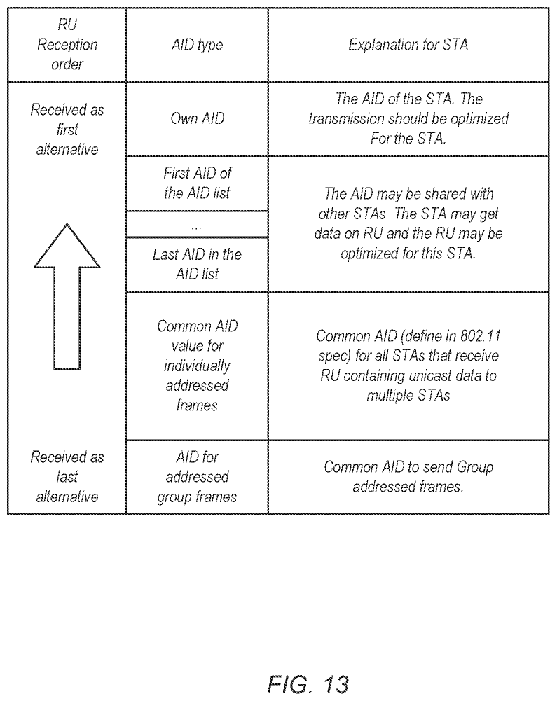

### FIG. 13: AID Receive Order of DL RU Allocations

As previously mentioned, multiple AID values may be transmitted by a transmitter to a device. The preamble of the MU PPDU may therefore contain multiple listened-AID values that the STA is intended to receive. Typically, an STA is capable of receiving transmissions on RU(s) that are associated with (e.g., identified by) the same AID value. FIG. 13 illustrates an example RU selection table for the STA in case the MU PPDU contains multiple listened-AID values that the STA is intended to receive.

When an STA is intended to receive data on an RU associated with (or identified by) multiple AID values, and the received MU PPDU contains multiple listened-AID values that the STA is intended to receive, then the STA may need to select the appropriate received RU(s), e.g., the appropriate RU(s) to monitor. The STA may receive RU(s) associated with (or identified by) a single AID value and may ignore other RU allocations. The received RU may be identified or selected according to a listened-AID priority rule, as illustrated in FIG. 13. If the received MU PPDU contains no listened-AID values that the STA is intended to receive, then the STA may ignore the RU allocations conveyed by the MU PPDU.

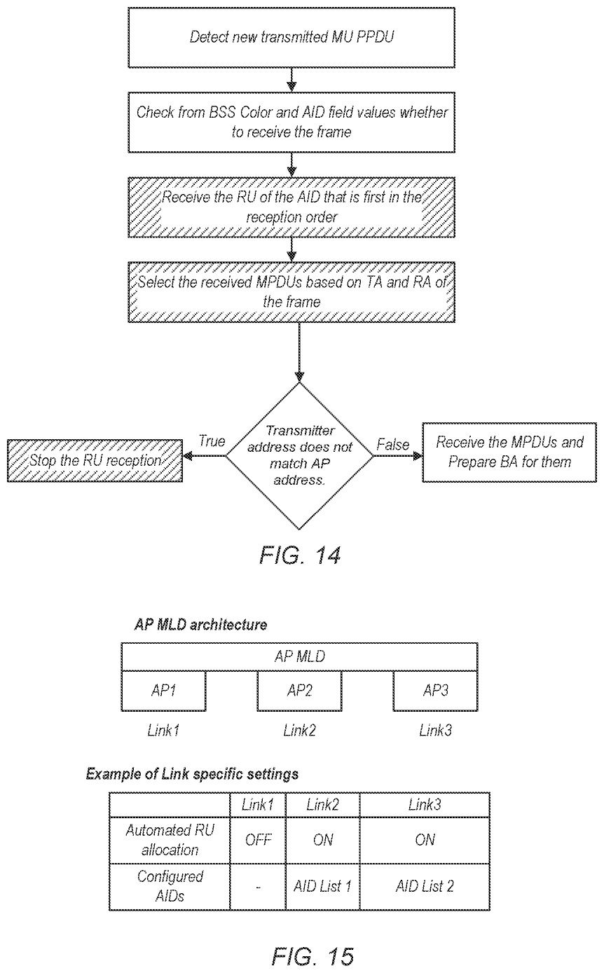

### FIG. 14: Receiver Operation on A-MPDU

Pursuant to the above, the DL MU RU reception flow may include new steps, indicated by the shaded boxes in FIG. 14. As previously mentioned, an MU PPDU uses the STA_ID field to signal the intended receiver for the RU, e.g., the receiver that is intended to monitor the RU. When the RU is allocated to an STA, the STA ID is set to the AID identifying or associated with STA, with the RU also identified by using the AID value. For example, the received MU PPDU preamble may contain a BSS color value that corresponds to (or is associated with) the AP/transmitter from which the given STA is intended to receive transmission(s). The MU PPDU preamble may also contain one or more listened-AID values that the given STA is intended to receive. As previously mentioned, the STA may need to identify/select the RU(s) on which it is to receive data. If the RU(s) that the given STA selects contain(s) a transmitter MAC address in the MAC address of the MPDU that does not correspond to or does not identify the assumed transmitter, then the given STA recognizes that the transmitter is unaware of the given STA, and the RU will not carry MPDUs addressed to the given STA. If the given STA recognizes that it will not be receiving MPDUs, it may stop receiving this MU PPDU frame. Otherwise, the STA may receive the MPDUs that have the receiver address (RA) in the MAC header of the MPDU set to the STA's MAC address.

As illustrated in FIG. 14, the STA may detect a newly transmitted MU PPDU (1402). For example, the STA may receive a legacy preamble and may synchronize with it. Next, the STA may determine/identify, based at least on the BSS color and AID field values (more generally, based at least on specific preamble fields, e.g., SIG-A field and SIG-B field), whether to receive the frame (1404). The STA may then select the RU associated with the AID (or listened-AID) that is first in the reception order (1406). More generally, the STA may determine/select the RU to monitor based on certain information in the preamble. The STA may then determine, e.g., based on the TA and RA corresponding to or associated with the frame, which MPDU(s) to receive (1408). If the TA address (e.g., in the MAC address of the MPDU) does not match the address of the assumed or expected transmitter, the STA may stop reception on (may stop monitoring) the RU (1410). Otherwise, the STA may receive the MPDUs addressed to the STA by virtue of the RA in the MAC header of the MPDU(s) identifying or being associated with the STA (1412).

### FIG. 15: MLD Specific Configuration or Link Specific Configuration

FIG. 15 shows an example structure for AP MLD architecture and link specific settings for configuring RU allocations. A non-AP multi-link device (MLD) may be configured to have the same RU allocation rule for all links. The RU allocation rule defines the listened-AID values and whether a given (single) RU may carry traffic to two or more receivers. Alternatively, the RU allocation rule may be enabled/configured link specifically. The received (by the STA) AID list may be common for all links, or the received AID value may be configured per link. When RU allocation is configured per link, the AP may steer the STA to listen more on a specific link. For example, the AP may not enable RU sharing in a link in which the non-AP MLD has a low throughput, as transmissions to other STAs may take a long time to complete and the STA may consume considerable power. Different link-specific listened-AID values may help AP scheduling. For example, another STA may operate only in a given link (e.g., link 2), so that the AP may configure the AID of another STA only to be received on link 2.

The default case may be all APs sharing the same listened-AID values and the RU enabled for all different APs. As shown in FIG. 15, an AP multilink device (MLD) may contain multiple affiliated APs. For example, AP1 may operate on 2.4 GHz, AP2 may operate on 5 GHz, and AP3 may operate on 6 GHz. Unicast frames may be transmitted on any of these APs and the recipient may maintain the same encryption and same sequence numbers. Accordingly, the recipient may reorder frames transmitted on any of these links (Link1, Link2, Link3), allowing the unicast traffic to propagate through any of the links. As also shown in FIG. 15, there may be different link-specific settings, leading to the AP selecting the link according to those specific settings, e.g., according to how well the settings match certain requirements, and may steer the STA to listen on the selected link.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising:
a processor configured to:
cause a wireless station to receive a payload from a transmitter on a first resource unit (RU) on which communications between the transmitter and a second wireless station are also taking place.

2. The apparatus of claim 1, wherein the processor is further configured to:
cause the wireless station to receive the payload in a multiuser physical protocol data unit (MU PPDU).

3. The apparatus of claim 1, wherein the payload comprises a latency-sensitive payload.

4. The apparatus of claim 1, wherein the processor is further configured to:
cause the wireless station to receive information instructing the wireless station to monitor the first RU to receive the payload on the first RU.

5. The apparatus of claim 4, wherein the information comprises a station identifier identifying the second wireless station as a companion station to the wireless station, wherein the processor is further configured to cause the wireless station to monitor an RU associated with the companion station.

6. The apparatus of claim 4, wherein the processor is further configured to:
cause the wireless station to determine whether a preamble of a received packet indicates that an RU is allocated to a companion station; and
listen for the packet on the RU in response to determining that the RU is allocated to the companion station.

7. The apparatus of claim 4, wherein an identifier value associated with the companion station changes after a specified time period or after a specified number of packets have been received by the wireless station.

8. The apparatus of claim 1, wherein the processor is further configured to:
receive information in a dedicated user field in a preamble of a received packet, wherein the information comprises:
a station identifier of the wireless station; and
an identifier of the first RU.

9. The apparatus of claim 8, wherein one or more RU properties for receiving the payload on the first RU are different relative to one or more RU properties for the communications currently ongoing on the first RU between the transmitter and the second wireless station.

10. The apparatus of claim 8, wherein a first portion of the preamble indicates a presence of the dedicated user field in the preamble.

11. The apparatus of claim 1, wherein the processor is further configured to:
cause the wireless station to transmit a delayed block acknowledgment to the transmitter in response to successfully receiving the payload.

12. The apparatus of claim 1, wherein the transmitter comprises a wireless access point.

13. A wireless station comprising:
radio circuitry configured to transmit and receive signals for wireless communications of the wireless station; and
a processor communicatively coupled to the radio circuitry and configured to:
interoperate with the radio circuitry to receive, from a transmitter, a payload on a first resource unit (RU) on which communications between the transmitter and a second wireless station are also taking place.

14. The wireless station of claim 13, wherein the processor is configured to further interoperate with the radio circuitry to receive information instructing the wireless station to monitor the first RU to receive the payload on the first RU.

15. The wireless station of claim 14, wherein the information comprises a station identifier identifying the second wireless station as a companion station to the wireless station, wherein the processor is further configured to cause the wireless station to monitor an RU associated with the companion station.

16. The wireless station of claim 15, wherein an identifier value associated with the companion station changes after a specified time period or after a specified number of packets have been received by the wireless station.

17. An apparatus comprising:
a processor configured to:
cause a wireless station to detect a newly transmitted multiuser physical protocol data unit (MU PPDU);
determine, based at least on first information within a preamble of the MU PPDU, whether to receive a frame within the MU PPDU;
identify, based at least on second information within the preamble, a resource unit (RU); and
select, based at least on a transmitter address and a receive address indicated by the MU PPDU, which media access control protocol data units (MPDUs) of the MU PPDU to receive over the RU.

18. The apparatus of claim 17, wherein the processor is configured to:
cause the wireless station to stop reception on the RU when the transmitter address does not match an assumed transmitter address.

19. The apparatus of claim 17, wherein the processor is configured to:
cause the wireless station to generate a block acknowledgment corresponding to the received MPDUs.

20. The apparatus of claim 17, wherein the second information comprises an association identifier (AID) associated with the RU, wherein the AID is first in a reception order of received AID s.
